(19) United States
(12) Patent Application Publication
(10) Pub. No.: US 2026/0291349 A1
(43) Pub. Date: Sep. 24, 2026

(54) METHOD FOR PRODUCING AT LEAST ONE LIQUID CHANNEL IN A LAMINATED CORE, LAMINATED CORE PRODUCED THEREWITH, AND ELECTRIC MACHINE HAVING SAID LAMINATED CORE

(71) Applicant: voestalpine Stahl GmbH, Linz (AT)

(72) Inventor: Ronald Fluch, Linz (AT)

(21) Appl. No.: 19/478,368

(22) PCT Filed: Apr. 25, 2023
(86) PCT No.: PCT/EP2023/060867

§ 371 Date: Oct. 24, 2025

(51) Int. Cl. H02K 15/0273; B32B 3/26; B32B 7/12; B32B 15/01; H02K 1/20; H02K 1/32; H02K 15/027

(52) U.S. Cl. CPC H02K 15/0273; B32B 3/266; B32B 7/12; B32B 15/01; H02K 1/20; H02K 1/32; H02K 15/027; B32B 2457/00

(57) ABSTRACT

A method for producing at least one liquid channel in a laminated core, a laminated core produced therewith, and an electric machine having said laminated core are disclosed. In order to enable achievement of outstanding properties, it is proposed for at least two openings of the sheet metal parts to each have a collar with tabs, wherein these collars engage with one another along the liquid channel and overlap with one another at least by means of their tabs.

### FIELD OF THE INVENTION

The invention relates to a method for producing at least one liquid channel in a laminated core, in which multiple openings with a circumference contour are produced, more particularly punched, into a piece of sheet metal or a sheet metal strip that at least has an adhesive, more particularly hot-melt adhesive varnish, on at least one flat side, multiple sheet metal parts are subsequently separated from the piece of sheet metal or the sheet metal strip, which sheet metal parts each have at least one of said openings, the sheet metal parts are stacked on top of one another in such a way that the openings define at least the liquid channel extending in the laminated core, more particularly extending in the axial direction, and the stacked sheet metal parts are bonded to one another by means of the glue to form the laminated core.

### BACKGROUND OF THE INVENTION

To cool a laminated core of a stator of an electric machine, namely a generator, it is known (EP2109206A1, DE29707181U1) to provide an axial liquid channel in the laminated core of the stator, which channel is defined by openings in sheet metal parts of the laminated core.

To accomplish this—for example by using a lamination stacking process—these sheet metal parts are stamped out of a piece of sheet metal or a sheet metal strip into which openings for the liquid channel have previously been punched. After the sheet metal parts are stacked on top of one another, they are laminated to form the laminated core, thus producing an axial liquid channel in the laminated core. The lamination can also, as disclosed in DE29707181U1, be performed by means of gluing.

Coolant flows through the liquid channel and problems of leakage in the liquid channel, for example due to lamination defects, are countered by using an electrically insulating coolant.

This does prevent electrical short-circuits—but escaped coolant disadvantageously increases the rotational resistance in the electric machine, which in turn reduces its efficiency.

In addition, laminated cores in the high-performance range also require a high pressure resistance in order to be able to ensure adequate cooling.

### SUMMARY OF THE INVENTION

The object of the invention, therefore, is to modify a method of the type described at the beginning in such a way that produces a liquid-tight liquid channel in the laminated core in a reproducible way, which liquid channel also has a high pressure resistance and a high efficiency in the temperature control of the laminated core. The method should also be easy to implement and enable an economical production of laminated cores that is efficient in terms of time.

If the circumference contours of at least two produced openings have multiple tabs, more particularly ones oriented radially inward, then it is possible to provide a structure inside the liquid channel that can increase the pressure resistance of the laminated core. For example, the tabs can be oriented radially inward in this method step.

Subsequently, a collar is produced in each of the at least two openings by means of forming so that these collars are embodied in such a way that they engage in one another over the length of the liquid channel and overlap one another at least by means of their tabs when sheet metal parts that have these collars are stacked on top of one another. This overlapping of the tabs can specifically make it more difficult for liquid to penetrate into the adhesive bond between the sheet metal parts and especially, these overlapping tabs are also pressed against one another in accordance with the pressure of the liquid. The laminated core can therefore be embodied to be significantly more resistant to leakage. In addition, depending on the selected contour of the tabs, it is also possible to alter the efficiency of the cooling of the laminated core, for example by selecting the contour of the overlapping tabs in such a way that a turbulent flow occurs or increases in the liquid channel, yielding a high heat transfer between the liquid and the laminated core.

In addition, the method for producing the tabs and a collar can be carried out with method steps of the same type used to produce the openings in the piece of sheet metal or the sheet metal strip or in the sheet metal part so that the method can remain user-friendly, efficient in terms of time, and economical. For example, the forming used to produce the collar can be an embossing. The collars can, for example, be produced in the piece of sheet metal or the sheet metal strip by means of forming. By contrast with the prior art, the method according to the invention can therefore feature a significantly higher processing speed. It can also be advantageous if the laminated core produced in this way is used for an electric machine such as an electric motor or electric generator.

Preferably, the tabs in each opening are evenly distributed one after another in the circumference direction in order to embody the liquid channel as uniformly constant in all radial directions.

This can be further improved, for example, if the tabs are embodied as essentially identical in their dimensions, making it possible to exploit symmetries. This can also further increase the reproducibility of the method.

For example, if the circumference contour between the tabs is slot-shaped or funnel-shaped, then this can further facilitate the forming at the openings that produces the collars.

Preferably, the circumference contour at the tabs is curved. For example, this can further improve the heat transfer between the liquid and the laminated core through improved flow conditions in the cooling channel. This is especially true if the circumference contour at the tabs is circularly curved.

The circumference contour at the tabs can, however, also be rectangular.

Preferably, the tabs are produced with a tab height that is 0.05 to 5 times the thickness of the piece of sheet metal or the sheet metal strip in order to provide a sufficient overlapping of the tabs.

It is also conceivable for the tabs to be produced with a tab width in the range from 1 to 20 times the tab height in order to further facilitate the forming of the collars.

This liquid resistance and efficiency in the temperature control can be further increased, for example, if—when the sheet metal parts are stacked on top of one another—the tabs on the collar of one sheet metal part and the tabs on the collar of the subsequent sheet metal part are positioned offset from one another in the circumferential direction. For example, the tabs of the collars can overlap like scales. This offset can, for example, be by one half of a tab width. For example, the relative offset of the tabs can be achieved by rotating the stack or the sheet metal part that is to be placed onto the stack, which is comparatively easy to accomplish and simplifies the method for producing the laminated core.

The media-tightness of the liquid channel can be further improved, for example, if the collars each have a conical section, more particularly a section embodied as frustoconical in cross-section, that is adjoined by the tabs. More particularly, the conical section adjoins the sheet plane of the piece of sheet metal or the sheet metal strip or the sheet metal part. Preferably, the collars are embodied as frustoconical in cross-section in their conical section—which can further simplify the method for producing these collars.

Preferably, the conical sections are produced with a section width in the range from 0.2 to 2 times the thickness of the piece of sheet metal or the sheet metal strip in order to achieve an even better seal of the liquid channel.

For example, conical sections are produced with a section height in the range from greater than or equal to 0.5 times to less than or equal to 2 times the thickness of the piece of sheet metal or the sheet metal strip in order to achieve a further improvement in the sealing of the liquid channel.

The liquid channel can be produced in an easy-to-implement way over the total length of the laminated core if, apart from the first sheet metal part in the laminated core, all of the sheet metal parts that are stacked after this first sheet metal part have collars with tabs on their openings for the liquid channel.

For example, the method for producing the laminated core can be simplified if the collars are pressed into the piece of sheet metal or the sheet metal strip and/or into the sheet metal part by means of forming, which makes it possible to produce identically embodied collars economically and with reproducible dimensions. This pressing can take place, for example, by means of an embossing procedure.

Another object of the invention is to produce a laminated core with a liquid channel, which laminated core has a high pressure resistance to liquid pressure and a high efficiency in the temperature control by means of the liquid channel.

The fact that at least two openings of the sheet metal parts each have a collar with tabs, wherein these collars engage with one another along the liquid channel and overlap at least by means of their tabs, firstly allows an increase in the pressure resistance in the region of the liquid channel through the lengthening of the integral bond between the sheet metal parts. In addition, the wall structure of the liquid channel that is produced by the overlapping tabs can be used to adjust and optimize the efficiency of the temperature control of the laminated core. It is thus possible to achieve a laminated core that is durable and also has highly efficient temperature control.

Preferably, the circumference contour between the tabs is slot-shaped or funnel-shaped, which can further improve the efficiency of the cooling channel in the temperature control of the laminated core.

The foregoing can be further improved if, for example, the circumference contour of the tabs is curved or rectangular. For example, the tabs can be circularly curved.

Preferably, the tabs on the collar of one sheet metal part are positioned offset in the circumferential direction from the tabs on the collar of the subsequent sheet metal part in order to enable a comparatively high pressure resistance by means of a scale-like overlapping. This offset can, for example, be by one half of a tab width.

Preferably, the tabs have a tab height in the range from 0.05 to 5 times the thickness of the sheet metal part and/or a tab width in the range from 1 to 20 times the tab height.

The liquid-tight connection between the sheet metal parts can be further improved if the collars each have a conical section, more particularly a section embodied as frustoconical in cross-section, that is adjoined by the tabs.

For example, the conical sections have a section width in the range from 0.2 to 2 times the thickness of the sheet metal part and/or a section height in the range from 0.5 times to 2 times the thickness of the sheet metal part.

More particularly, the laminated core according to the invention is suited for use in an electric machine. The electric machine can, for example, be an electric motor or electric generator. For example, the laminated core is a rotor or a stator of the electric machine.

### BRIEF DESCRIPTION OF THE DRAWINGS

The subject of the invention is shown in greater detail in the figures with the aid of one embodiment by way of example. In the drawings:

FIG. 1 shows a schematic view of a device for producing laminated cores with a liquid channel,

FIG. 2 shows an enlarged top view of a sheet metal part produced with the device according to FIG. 1 before the forming of the collar,

FIG. 3 shows an enlarged three-dimensional view of a sheet metal part produced with the device according to FIG. 1 after the forming of the collar, and

FIG. 4 shows an enlarged partial view of two collars that engage with each other and belong to two sheet metal parts of the laminated core from FIG. 1.

### DETAILED DESCRIPTION OF THE INVENTION

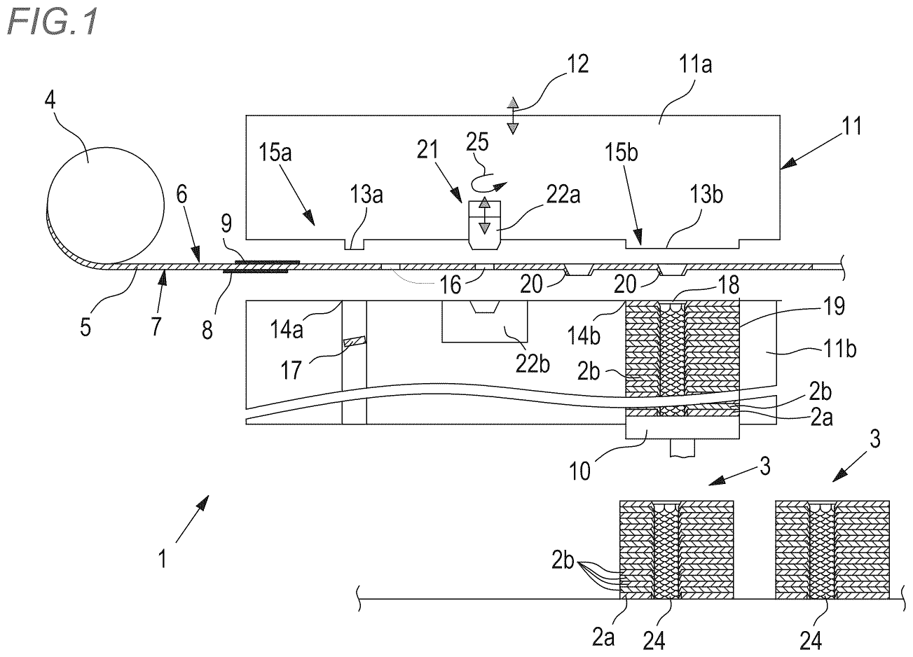

FIG. 1 schematically depicts an exemplary embodiment of a device 1 for carrying out the method according to the invention. This device 1 is used for stacking stamped-out sheet metal parts 2a, 2b into laminated cores 3. This method therefore constitutes a lamination stacking process. The laminated core 3 produced in this way can be used, for example, in an electric machine.

For this purpose, a sheet metal strip 5, namely composed of electrical strip (or of an electrical sheet in the case of a piece of sheet metal), which is completely covered with an adhesive layer 8, 9, namely a heat-hardening hot-melt adhesive layer such as backlack, on both flat sides 6, 7, is unwound from a coil 4. These hot-melt adhesive layers 8, 9 are shown in an exaggerated enlargement in FIG. 1.

This electrical strip/electrical sheet, which is typically composed of an iron-silicon alloy, is manufactured for example in the form of non-grain-oriented sheets or grain-oriented sheets. Because of their isotropic magnetic properties, non-grain-oriented electrical sheets are mainly used in rotating machines such as electric motors.

It should be noted in general that such a hot-melt adhesive varnish layer 8, 9 or hot-melt adhesive layer, more particularly a thermally activatable and thus heat-hardening one, is also known by the term “backlack”. For example, the hot-melt adhesive varnish can be epoxy resin-based. Preferably, the hot-melt adhesive varnish is a bisphenol-based epoxy resin system with a hardener, for example a dicyandiamide-based hardener. More particularly, the above-mentioned hot-melt adhesive varnish can be a bisphenol-A-epichlorohydrin resin system with dicyanamide as a hardener. This two-stage hardening epoxy resin system is in the B state on the sheet metal strip 5. The partially cross-linked hot-melt adhesive varnish is therefore reactive. When heat is supplied, the hot-melt adhesive varnish in the B state reacts further and can thus be brought into the fully cross-linked C state—which is also referred to as baking. Typically, this partially cross-linked hot-melt adhesive varnish layer 8, 9 has a thickness of a few micrometers.

Preferably, the thickness d of the piece of sheet metal or the sheet metal strip 5 and thus also the thickness d of the sheet metal parts 2a, 2b is from 0.1 mm (millimeters) to 0.35 mm, preferably from 0.2 mm to 0.3 mm. Preferably, the sheet metal strip 5 has a thickness d of 0.3 mm (millimeters).

Multiple sheet metal parts 2a, 2b are separated, namely stamped out from, the adhesive-coated sheet metal strip 5 with the aid of a stamping tool 11—a progressive stamping tool in the exemplary embodiment. It should in general be noted that such a stamping-out can be a cutting-out, cutting-off, detaching, trimming, breaking up by popping out, etc.

As can also be inferred from FIG. 1, the stamping tool 11 carries out a cutting with multiple strokes 12. To accomplish this, the blades 13a, 13b in the upper tool 11a of the stamping tool 11 cooperate with the respective dies 14a, 14b of the lower tool 11b of the stamping tool 11 and thus constitute two stamping stages 15a, 15b in the stamping tool 10.

With the first blade 13a of the upper tool 11a, multiple openings 16 with a circumference contour 23 are produced in the sheet metal strip 5, namely are punched into it, which is evident from the punched-out remainder 17 in FIG. 1. With the second blade 13b, the sheet metal part 2a or 2b is separated from the sheet metal strip 5, for example by being stamped out or also pressed out, etc.

The openings 16 are provided in the sheet metal strip 5 for each separated sheet metal part 2a, 2b since in the laminated core 3, this opening 16 defines a liquid channel 18 that passes axially all the way through the laminated core 3, as shown in FIG. 1. The axial liquid channel 18 is also positioned eccentrically in the laminated core 3.

Then with the aid of the stamping stage 15b, the sheet metal parts 2a, 2b are stamped out and, through the pressing of the upper tool 11a, are pushed into a stacking device 19 and stacked therein. The stacking device 19 has a guide in the lower tool 11b for this purpose. A counter-support 10 is also provided in the guide.

The stacking device 19 is actively heated in order to activate the adhesive, namely the thermosetting hot-melt adhesive varnish 8, 9 in the example, and produce an adhesive bond or integral bond between the sheet metal parts 2 by means of baking. This laminates the sheet metal parts 2a, 2b to one another and to the laminated core 3.

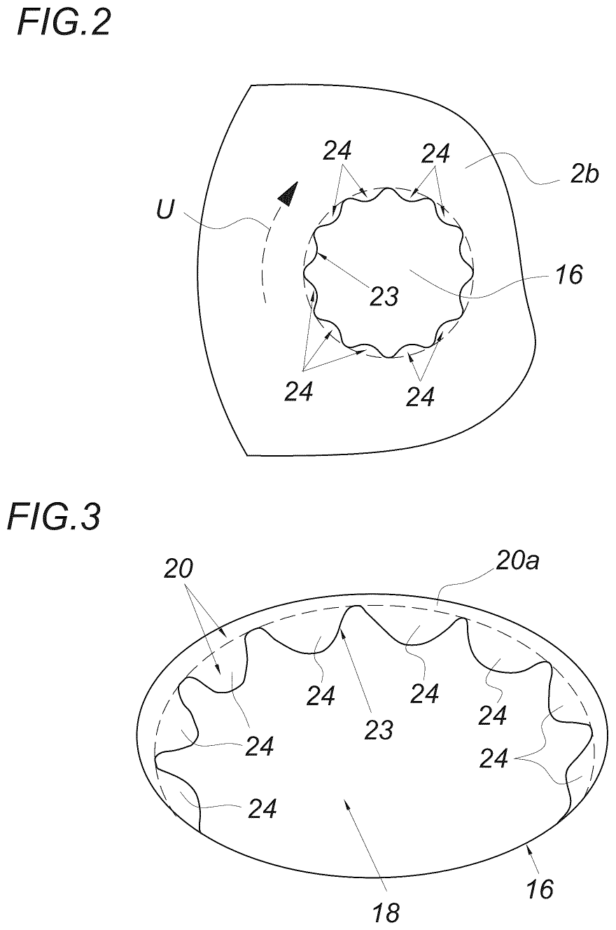

In order to produce a liquid channel 18 that is extremely media-tight in terms of leakage, special openings 16 are produced and specifically, the circumference contours 23 of these produced openings 16 have a plurality of tabs 24 oriented radially inward, as shown in FIG. 2.

Subsequently, the openings that have been produced in the sheet metal strip 5 are each provided with a collar 20 that is produced by means of embossing with a punch 22a and a die 22b in the forming stage 21. The collars 20 of the sheet metal parts 2b are embodied in such a way that they engage in one another in the longitudinal direction L of the liquid channel 18 and overlap one another at least with their tabs 24 when sheet metal parts 2b that do in fact have these collars 20 are stacked on top of one another. This produces a particularly tight connection of the sheet metal parts 2b—and thus protects the liquid channel 18 against leakage of liquid.

In order to avoid having the tabs 24 protrude out from the liquid channel 18, the first respective sheet metal part 2a of a laminated core 3 does not have such a collar 20 with tabs 24.

These tabs 24 are also evenly distributed one after another in the circumference direction U of the respective opening 16 and are embodied as essentially identical in their dimensions. FIGS. 2 to 4 show that the first section 23a of the circumference contour 23 at the tabs 24 extends in a circular curve. The second section 23b of the circumference contour 23 between two adjacent tabs 24 is funnel-shaped.

It is also conceivable, however, (though this is not shown) for this first section 23a of the circumference contour 23 to be rectangular. In this case, the second section 23b can be slot-shaped.

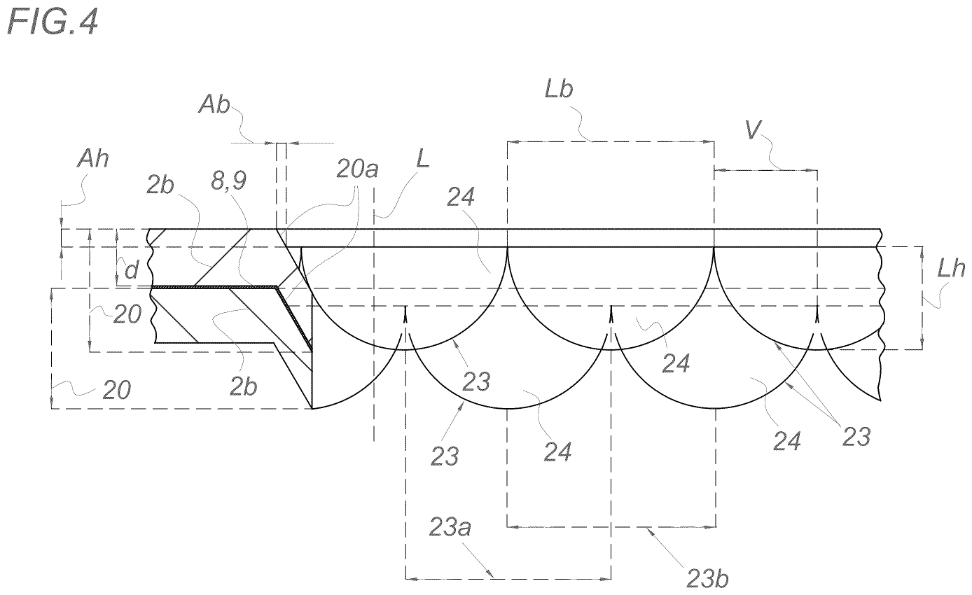

As can also be inferred from FIG. 4, all of the tabs 24 have a tab height Lh in the range from 0.05 to 5 times the thickness d of the piece of sheet metal or the sheet metal strip 5, namely 0.3*2=0.6 mm (millimeters).

The tab width Lb of all of the tabs 24 is in the range from 1 to 20 times the tab height Lh, namely 0.6*10=6 mm (millimeters).

As is also clear from FIG. 4, the tabs 24 on the collar 20 of the one piece of sheet metal 2b are offset in the circumference direction U from the tabs 24 on the collar 20 of the sheet metal part 2b adjacent to this. The offset V shown by way of example in FIG. 4 equals half of the tab width Lb of the tabs 24 that are essentially identical in their dimensions.

The tabs 24 of the one collar 20 can, however, also be positioned in gaps between the tabs 24 of the next collar 20.

This offset V can be achieved in a user-friendly way by rotating the blade 13a of the upper tool 11a in a rotation direction 25. If a laser is used instead of a blade 13a, then its path can be adapted accordingly. It is also conceivable to rotate the stacked sheet metal parts 2a, 2b or the sheet metal part 2b that is to be added to the stack, which is also not shown in detail.

As is shown in FIG. 3, the collars 20 each have a conical section 20a that is adjoined by the tabs 24. As is also shown in FIG. 3, the conical section 20b is embodied as frustoconical in cross-section. It is also conceivable, however, for the collars 20 to consist exclusively of the tabs 24, which is not shown in detail.

The conical section 20a has a section width Ab of 0.10 mm (millimeters), which produces a particularly good seal of the liquid channel against leakage.

In addition, the section width Ah of the conical section 20a is 0.2 mm (millimeters), which is less than the thickness d and greater than half the thickness d of the sheet metal strip 5 or the sheet metal part 2b that is cut off from the strip. This produces a particularly stable collar 20 for a rugged media-tight connection between the sheet metal parts 2a, 2b.

It should be noted in general that the German expression “insbesondere” can be translated as “more particularly” in English. A feature that is preceded by “more particularly” is to be considered an optional feature, which can be omitted and does not thereby constitute a limitation, for example, of the claims. The same is true for the German expression “vorzugsweise”, which is translated as “preferably” in English.

1. A method for producing at least one liquid channel in a laminated core, comprising:
producing a plurality of openings in a piece of sheet metal or in a sheet metal strip that has an adhesive on at least one flat side, each of the plurality of openings having a circumference contour,
separating a plurality of sheet metal parts from the piece of sheet metal or the sheet metal strip, each of the plurality of sheet metal parts having at least one opening of the plurality of openings,
stacking the plurality of sheet metal parts on top of one another in such a way that the plurality of openings define the at least one liquid channel extending in the laminated core, and
bonding the stacked sheet metal parts to one another with the adhesive to form the laminated core,
wherein the circumference contours of at least two of the plurality of openings have a plurality of tabs, and
a collar is produced on each of the at least two openings
so that the collars engage in one another along the at least one liquid channel and overlap at least by their tabs when the sheet metal parts having the collars (20) are stacked on top of one another.

2. The method according to claim 1, wherein the tabs in each of the plurality of openings are evenly distributed one after another in a circumferential direction and/or the tabs are essentially identical in their dimensions.

3. The method according to claim 1, wherein the circumference contour between the tabs is slot-shaped or funnel-shaped.

4. The method according to claim 1, wherein the circumference contour at the tabs is curved or rectangular.

5. The method according to claim 1, wherein the tabs are produced with a tab height in a range from 0.05 to 5 times a thickness of the piece of sheet metal or the sheet metal strip and/or with a tab width in a range from 1 to 20 times the tab height.

6. The method according to claim 1, wherein when the plurality of sheet metal parts are stacked on top of one another, the tabs on the collar of one of the plurality of sheet metal parts and the tabs on the collar of a subsequent one of the plurality of sheet metal parts are positioned offset from one another in a circumferential direction.

7. The method according to claim 1, wherein the collars each have a conical section that is adjoined by the tabs.

8. The method according to claim 7, wherein the conical sections are produced with a section width in a range from 0.2 to 2 times a thickness of the piece of sheet metal or the sheet metal strip and/or with a section height in a range from 0.5 to 2 times the thickness of the piece of sheet metal or the sheet metal strip.

9. The method according to claim 1, wherein apart from a first sheet metal part in the laminated core, all of the plurality of sheet metal parts that are stacked after the first sheet metal part have collars with tabs on their openings for the liquid channel.

10. A laminated core with a liquid channel, comprising:
a plurality of sheet metal parts stacked on top of one another, and bonded to one another at least with an adhesive, wherein the plurality of sheet metal parts have openings, which define the liquid channel extending in the laminated core, wherein at least two of the openings of the plurality of sheet metal parts each have a collar with tabs, wherein the collars engage with one another along the liquid channel and overlap at least with their tabs.

11. The laminated core according to claim 10, wherein each of the plurality of openings has a circumference contour, and the circumference contour between the tabs is slot-shaped or funnel-shaped.

12. The laminated core according to claim 10, wherein each of the plurality of openings has a circumference contour, and the circumference contour at the tabs is curved or rectangular.

13. The laminated core according to claim 10, wherein the tabs on the collar of one of the plurality of sheet metal parts are positioned offset in a circumferential direction from the tabs on the collar of a subsequent one of the plurality of sheet metal parts.

14. The laminated core according to claim 10, wherein the tabs have a tab height in a range from 0.05 to 5 times a thickness of the sheet metal part and/or a tab width in a range from 1 to 20 times the tab height.

15. The laminated core according to claim 10, wherein the collars each have a conical section that is adjoined by the tabs.

16. The laminated core according to claim 15, wherein the conical sections have a section width in a range from 0.2 to 2 times a thickness of the sheet metal part and/or a section height in a range from 0.5 to 2 times the thickness of the sheet metal part.

17. An electric machine comprising the laminated core according to claim 10.

18. The method according to claim 1, wherein the plurality of tabs are oriented radially inward.

19. The method according to claim 6, wherein when the plurality of sheet metal parts are stacked on top of one another, the tabs on the collar of one of the plurality of sheet metal parts and the tabs on the collar of the subsequent one of the plurality of sheet metal parts are positioned offset from one another by one half of a tab width.

20. The method according to claim 7, wherein the conical section of each of the collars is frustoconical in cross-section.

21. The laminated core according to claim 13, wherein the tabs on the collar of one of the plurality of sheet metal parts and the tabs on the collar of the subsequent one of the plurality of sheet metal parts are positioned offset from one another by one half of a tab width.

22. The method according to claim 15, wherein the conical section of each of the collars is frustoconical in cross-section.
